(19) United States
(12) Patent Application Publication
(10) Pub. No.: US 2014/0172270 A1
(43) Pub. Date: Jun. 19, 2014

(54) METHOD TO REDUCE FUEL CONSUMPTION WHILE OPERATING A POWER TAKE OFF

(71) Applicants: Robert E. Lee, Brighton, MI (US); Brian E. Beechie, Armada, MI (US)

(72) Inventors: Robert E. Lee, Brighton, MI (US); Brian E. Beechie, Armada, MI (US)

(21) Appl. No.: 13/718,560

(22) Filed: Dec. 18, 2012

(51) Int. Cl. F02D 45/00

(52) U.S. Cl. CPC F02D 45/00
USPC 701/102

(57) ABSTRACT

A system and method for reducing fuel consumption of an engine while operating a power take off. Whenever practical, the system and method will operate the engine with fewer than all cylinders when operating a power take off. Operating the engine with fewer than all cylinders will reduce fuel consumption and improve fuel economy.

### FIELD

The present disclosure relates generally to controlling internal combustion engines and more particularly to a method of controlling an engine while operating a power take off.

### BACKGROUND

A power take-off (PTO) is a device that transfers power from an engine, such as e.g., a vehicle's engine, to an auxiliary piece of equipment, such as e.g., a hydraulic pump, air compressor, or vacuum pump. The PTO uses the vehicle's powertrain to drive the auxiliary equipment. Sometimes, for stationary PTO equipment/applications, the vehicle's engine is operated while the vehicle is in park (for automatic transmissions) or has its parking brake engaged (for manual transmissions).

While driving the PTO and attached equipment, the vehicle's engine will be operating on all cylinders. Although this is beneficial for driving the PTO and the equipment to ensure that the equipment is operating properly, the engine may be consuming more fuel than necessary. As can be appreciated, wasting fuel is always undesirable. Accordingly, there is a need and desire for reducing a vehicle's fuel consumption while the vehicle is operating a power take off.

### SUMMARY

In one form, the present disclosure provides a method of controlling an engine for power take off operation. The method comprises determining if the engine can be operated with less than all engine cylinders activated during power take off and operating the engine with less than all engine cylinders activated if it is determined that the engine can be operated with less than all engine cylinders activated during power take off.

The present disclosure also provides an engine system. The system comprises a controller connected to the engine. The controller is adapted to determine if the engine can be operated with less than all engine cylinders activated during power take off and operate the engine with less than all engine cylinders activated if it is determined that the engine can be operated with less than all engine cylinders activated during power take off.

In one embodiment, determining if the engine can be operated with less than all engine cylinders activated during power take off comprises determining that a requested engine power has not exceeded a maximum engine power achievable when operating the engine with less than all engine cylinders activated.

In other embodiments, the method is performed in a vehicle and determining if the engine can be operated with less than all engine cylinders activated during power take off further comprises determining that the vehicle is in park, determining that a parking brake of the vehicle is engaged, determining that a power take off enabled switch is set to enabled, and/or determining if the engine is operating.

Further areas of applicability of the present disclosure will become apparent from the detailed description provided hereinafter. It should be understood that the detailed description, including disclosed embodiments and drawings, are merely exemplary in nature intended for purposes of illustration only and are not intended to limit the scope of the invention, its application or use. Thus, variations that do not depart from the gist of the invention are intended to be within the scope of the invention.

### BRIEF DESCRIPTION OF THE DRAWINGS

FIG. 1 illustrates a system for controlling a vehicle's engine, according to an embodiment disclosed herein, while the vehicle is operating a power take off;

FIG. 2 illustrates a flowchart of a method of controlling a vehicle's engine, according to an embodiment disclosed herein, while the vehicle is stationary and operating a power take off; and

FIG. 3 illustrates a flowchart of a method of controlling a vehicle's engine, according to an embodiment disclosed herein, while the vehicle is moving and operating a power take off.

### DETAILED DESCRIPTION

The following description describes the disclosed embodiments as being used to control a vehicle's engine while operating a power take off. It should be appreciated, however, that the disclosed embodiments are not limited to controlling an engine within a vehicle. That is, the disclosed embodiments can be used to control any engine used to operate a power take off. For example, the disclosed embodiments can be implemented in a standalone power generating unit having an engine for operating a power take off. The disclosed system and method will reduce fuel consumption of the engine operating a power take off and, when implemented in a vehicle, will improve the vehicle's fuel economy. Whenever practical, the disclosed system and method will operate the engine with fewer than all cylinders when operating a power take off. As long as e.g., the power demanded by the power take off can be met, the system and method will continue to operate the engine with fewer than all cylinders.

One type of cylinder deactivation technique that is suitable for the disclosed system and method has been developed by Chrysler and is currently known as Chrysler's Multi-Displacement System (MDS). The MDS selectively deactivates cylinders at various times while the vehicle is moving based on performance needs and the capability to improve fuel economy. Currently, the MDS alternates between high-fuel-economy four-cylinder (V-4) mode when less power is needed (e.g., when the vehicle is cruising at a steady speed) and an eight-cylinder (V-8) mode when more power from the engine is needed (e.g., when the vehicle is accelerating).

As will become apparent, the MDS principles of cylinder deactivation and activation will be applied to the power take off situation, something which is not done today. It should be appreciated that, although the MDS technique has been described as switching between eight and four cylinder operation, the disclosed system and method are not limited to any particular cylinder deactivation technique. Moreover, more or less than four cylinders can be deactivated if desirable to do so. Likewise, the principles disclosed herein can apply to engines having more or less than eight cylinders.

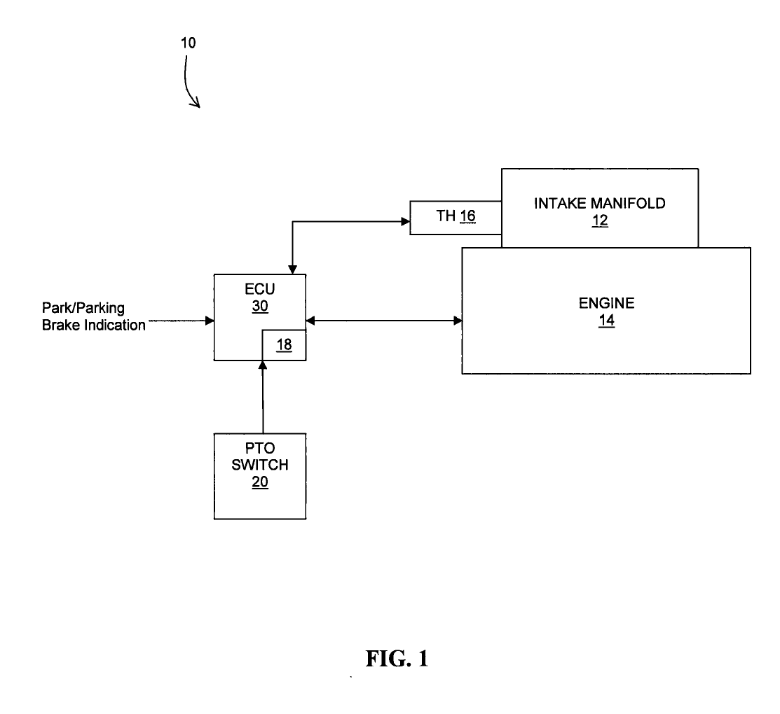

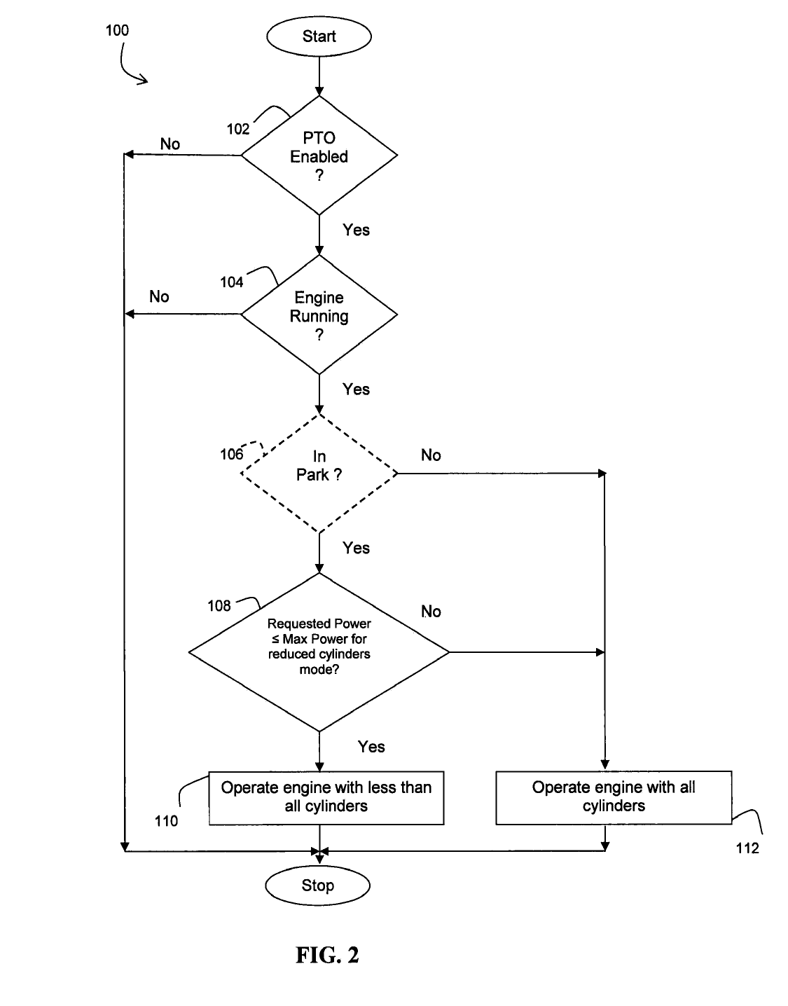

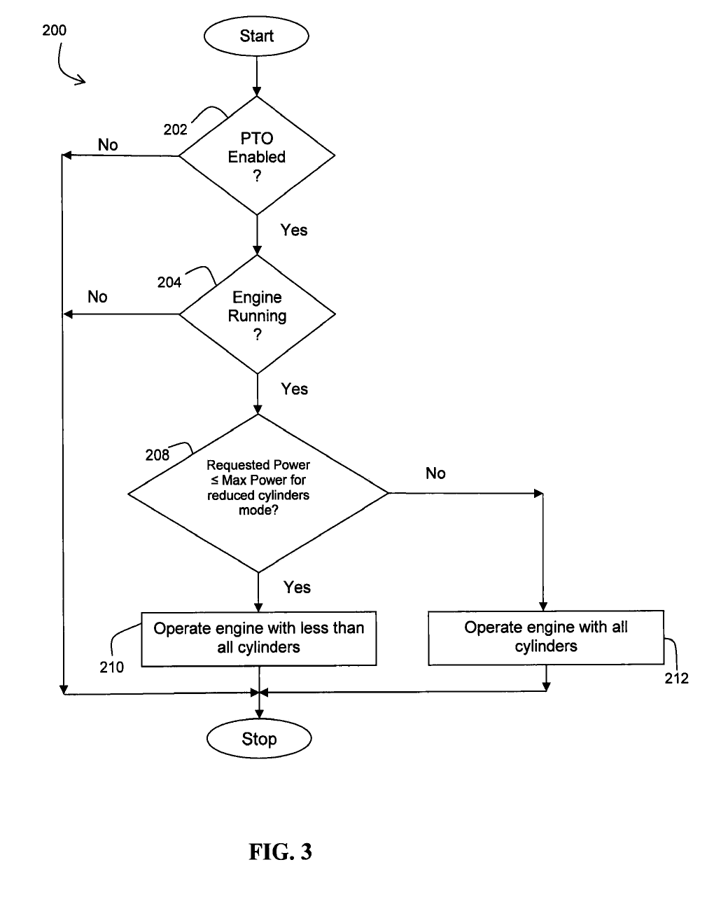

FIG. 1 illustrates an example system 10 for a vehicle that may be programmed to perform the novel control methods 100, 200 (FIGS. 2 and 3) disclosed herein. The system 10 comprises an intake manifold 12 connected to an engine 14. The engine 14 is also connected to an engine control unit (ECU) 30 or similar type controller. The ECU 30 could be a processor programmed to perform the methods 100, 200 discussed below and/or other necessary controller functions. The ECU 30 can receive an engine speed or other input from the engine 14 or sensor attached to the engine that indicates whether the engine 14 is on and/or what the engine speed is. A throttle (TH) 16 is connected to the intake manifold 12, receives inputs from control switches or similar control function 18 of the ECU 30, and outputs a throttle position or similar type of signal to the ECU 30. It should be noted that the control switches/function 18 could be a separate module/component of the system 10. It should also be appreciated that the control switches/function 18 can be associated with cruise control switches (not shown), a remote control (not shown) or other device that can be manipulated by a user. Thus, the system 10 and methods 100, 200 discussed below are not limited to the location of the control switches/function 18.

The ECU 30 is connected to the throttle 16 and a power take off (PTO) enabled switch 20. The PTO enabled switch 20 will output a signal having a first value indicating that PTO mode is enabled and a second value indicating that PTO mode disabled. The PTO enabled switch 20 will be set by an operator of the vehicle or auxiliary equipment. The ECU 30 is also adapted to receive a park/parking brake indicator when the system is implemented in a vehicle. The indicator will have a first value indicating that the vehicle is in park (for automatic transmissions) or has its parking brake engaged (for manual transmissions). The park/parking brake indicator will have a second value indicating that the vehicle is not in park (or does not have its parking brake engaged). This indicator will be useful for PTO activation when the PTO is used with stationary devices (discussed below with reference to method 100).

Once PTO is enabled (and the vehicle is in park/has its parking brake engaged if needed for a stationary PTO application), the control switches/function 18 of the ECU 30 and/or any corresponding switches within the vehicle will be used to control the PTO. For example, the engine speed can be set using a cruise control “set” button, accelerated using a cruise control “accel” button, or decelerated using a cruise control “decel” button. It should be appreciated that this is a typical control technique for PTO, but that the disclosed system and method are not limited to this type of control. For example, a remote control or other device can be used to set/accelerate/decelerate the desired engine speed. It should also be appreciated that a cruise control “on” button may be toggled to initiate and end engine control via the cruise control function 18.

As is discussed below in more detail, the ECU 30 will control the system 10, particularly the engine 14, such that the engine 14 will operate with less than all of its cylinders when operating a power take off and the circumstances allow such an operation. It should be appreciated that FIG. 1 illustrates one example system 10 and the principles disclosed herein are not limited solely to the FIG. 1 illustrated configuration.

FIG. 2 illustrates a method 100 of controlling the system 10 for a power take off operation when the vehicle is not moving (i.e., a stationary power take off situation) in accordance with an embodiment disclosed herein. In a desired embodiment, the method 100 is implemented in software, stored in a computer readable medium, which could be a random access memory (RAM) device, non-volatile random access memory (NVRAM) device, or a read-only memory (ROM) device) and executed by the engine control unit 30, which may be or include a processor, or other suitable controller within the system 10 of FIG. 1. Moreover, the computer readable medium can be part of the ECU 30.

The method 100 can be run periodically at a rate determined suitable or it can be triggered by an event such as e.g., recognizing that the PTO enabled switch 20 has been placed in the enabled position. In addition, it should be appreciated that illustrated steps 102-108 can be performed in any sequence, or in parallel. In the illustrated example, the method 100 begins when the ECU 30 determines if the PTO switch 20 has been set to PTO enabled (step 102). If the ECU determines that PTO is not enabled, then the method 100 terminates. If, however, the ECU 30 determines that PTO is enabled, then the ECU 30 determines whether the engine is running (at step 104). If it is determined that the engine is not running, the method 100 terminates.

If, however, it is determined that the engine is running, the method 100 continues at step 108. However, for some stationary PTO applications there may be a requirement for the vehicle to be in park or have its parking brake engaged. Thus, for these stationary PTO applications, an optional step may be performed where the ECU 30 determines if the vehicle is in park (or has its parking brake engaged)(optional step 106). The ECU 30 makes this determination based on the park/parking brake indicator. If optional step 106 is performed and if it is determined that the vehicle is in park (or has its parking brake engaged), the method 100 continues at step 108 where the ECU 30 determines whether the power requested is less than or equal to the maximum power achievable using less than all engine cylinders. Requested power can be derived from the information received from e.g., the cruise control switches, other control switches, remote control, etc. In the desired embodiment, with an engine having eight cylinders, the ECU 30 compares the requested power to the maximum power achievable using less than eight engine cylinders. If the engine had more or less than eight cylinders or a different number of desired cylinders were to be used, then the ECU 30 would compare the requested power to a corresponding maximum power achievable with the desired number of engine cylinders.

If the ECU 30 determines that the power requested is less than or equal to the maximum power achievable using less than all engine cylinders (at step 108), then all of the conditions have been met to operate PTO with less than all engine cylinders. In this case, the method continues at step 110 where the ECU 30 deactivates the desired number of cylinders and operates the engine 14 with less than all cylinders.

If the ECU 30 determines that the power requested is greater than the maximum power achievable using less than all engine cylinders (a no at step 108), then all of the conditions have not been met to operate the PTO with less than all engine cylinders. As such, the method 100 continues at step 112 where the ECU 30 ensures that all engine cylinders are activated and used to operate the engine 14. In an alternative embodiment, if the ECU 30 determines that the engine is not running (a no at step 104), the method 100 can continue at step 112 to allow the ECU 30 to activate all of the cylinders, if desired.

FIG. 3 illustrates a method 200 of controlling the system 10 for a power take off operation when the vehicle is moving (i.e., a non-stationary power take off situation) in accordance with an embodiment disclosed herein. In a desired embodiment, the method 200 is implemented in software, stored in a computer readable medium such as e.g., the ones discussed above, and executed by the engine control unit 30

The method 200 can be run periodically at a rate determined suitable or it can be triggered by an event such as e.g., recognizing that the PTO enabled switch 20 has been placed in the enabled position. In addition, it should be appreciated that illustrated steps 202-208 can be performed in any sequence, or in parallel. In the illustrated example, the method 200 begins when the ECU 30 determines if the PTO switch 20 has been set to PTO enabled (step 202). If the ECU determines that PTO is not enabled, then the method 200 terminates. If, however, the ECU 30 determines that PTO is enabled, then the ECU 30 determines whether the engine is running (at step 204). If it is determined that the engine is not running, the method 200 terminates.

If, however, it is determined that the engine is running, the method 200 continues at step 208 where the ECU 30 determines whether the power requested is less than or equal to the maximum power achievable using less than all engine cylinders. Requested power can be derived from the information received from e.g., the cruise control switches, other control switches, remote control, etc. In the desired embodiment, with an engine having eight cylinders, the ECU 30 compares the requested power to the maximum power achievable using less than eight engine cylinders. If the engine had more or less than eight cylinders or a different number of desired cylinders were to be used, then the ECU 30 would compare the requested power to a corresponding maximum power achievable with the desired number of engine cylinders.

If the ECU 30 determines that the power requested is less than or equal to the maximum power achievable using less than all engine cylinders (at step 208), then all of the conditions have been met to operate PTO with less than all engine cylinders. In this case, the method 200 continues at step 210 where the ECU 30 deactivates the desired number of cylinders and operates the engine 14 with less than all cylinders.

If the ECU 30 determines that the power requested is greater than the maximum power achievable using less than all engine cylinders (a no at step 208), then all of the conditions have not been met to operate the PTO with less than all engine cylinders. As such, the method 200 continues at step 212 where the ECU 30 ensures that all engine cylinders are activated and used to operate the engine 14. In an alternative embodiment, if the ECU 30 determines that the engine is not running (a no at step 204), the method 200 can continue at step 212 to allow the ECU 30 to activate all of the cylinders, if desired.

The system 10 and methods 100, 200 disclosed herein provide several advantages over the prior art. The system 10 and methods 100, 200 will operate the engine with less than all cylinders for as long as practical, reducing pumping work and conserving fuel. However, when more power is needed, the engine will be seamlessly switched back to all cylinder operation.

The system 10 and methods 100, 200 disclosed herein are suitable for use with trucks such as the Dodge RAM® medium duty and heavy duty vehicles, which are known for their PTO use. It should be appreciated, however, that the system 10 and methods 100, 200 are not limited to any particular PTO equipment, device, type of vehicle or transmission type. That is, the system 10 and methods 100, 200 can be used in trucks, sport utility vehicles, automobiles with either four wheel drive, all wheel drive, or two wheel drive and can be used to drive stationary and non-stationary PTO equipment. It should also be appreciated that the system 10 and methods 100, 200 can be implemented in a standalone power generating unit having an engine and need not be implemented within a vehicle.

What is claimed is:

1. A method of controlling an engine for power take off operation, said method comprising:
determining if the engine can be operated with less than all engine cylinders activated during power take off; and
operating the engine with less than all engine cylinders activated if it is determined that the engine can be operated with less than all engine cylinders activated during power take off.

2. The method of claim 1, wherein determining if the engine can be operated with less than all engine cylinders activated during power take off comprises determining that a requested engine power has not exceeded a maximum engine power achievable when operating the engine with less than all engine cylinders activated.

3. The method of claim 2, wherein determining that the requested engine power has not exceeded the maximum engine power achievable when operating the engine with less than all engine cylinders activated comprises determining the requested power from a cruise control setting.

4. The method of claim 2, wherein the method is performed in a vehicle comprising the engine and the step of determining if the engine can be operated with less than all engine cylinders activated during power take off further comprises determining that the vehicle is in park.

5. The method of claim 2, wherein the method is performed in a vehicle comprising the engine and the step of determining if the engine can be operated with less than all engine cylinders activated during power take off further comprises determining that a parking brake of the vehicle is engaged.

6. The method of claim 2, wherein determining if the engine can be operated with less than all engine cylinders activated during power take off further comprises determining that a power take off enabled switch is set to enabled.

7. The method of claim 2, wherein determining if the engine can be operated with less than all engine cylinders activated during power take off further comprises determining if the engine is operating.

8. The method of claim 1, wherein the engine comprises eight cylinders and said step of operating the engine with less than all cylinders activated comprises deactivating one or more engine cylinders.

9. The method of claim 1, wherein if it is determined that the engine cannot be operated with less than all engine cylinders activated during power take off, said method further comprises operating the engine with all engine cylinders activated.

10. An engine system comprising:
a controller connected to the engine, said controller adapted to:
determine if the engine can be operated with less than all engine cylinders activated during power take off; and
operate the engine with less than all engine cylinders activated if it is determined that the engine can be operated with less than all engine cylinders activated during power take off.

11. The system of claim 10, wherein the controller determines if the engine can be operated with less than all engine cylinders activated during power take off by determining that a requested engine power has not exceeded a maximum engine power achievable when operating the engine with less than all engine cylinders activated.

12. The system of claim 11, further comprising a cruise control function, wherein the controller determines that the requested engine power has not exceeded the maximum engine power achievable when operating the engine with less than all engine cylinders activated by determining the requested power from a cruise control setting input from the cruise control function.

13. The system of claim 11, wherein the system is implemented in a vehicle and the controller determines if the engine can be operated with less than all engine cylinders activated during power take off by also determining that the vehicle is in park.

14. The system of claim 11, wherein the system is implemented in a vehicle and the controller determines if the engine can be operated with less than all engine cylinders activated during power take off by also determining that a parking brake of the vehicle is engaged.

15. The system of claim 11, wherein the controller determines if the engine can be operated with less than all engine cylinders activated during power take off by also determining that a power take off enabled switch is set to enabled.

16. The system of claim 11, wherein the controller determines if the engine can be operated with less than all engine cylinders activated during power take off by also determining if the engine is operating.

17. The system of claim 10, wherein the engine comprises eight cylinders and said controller operates the engine with less than all cylinders activated by deactivating one or more engine cylinders.

18. The system of claim 10, wherein the controller operates the engine with all engine cylinders activated if it determines that the engine cannot be operated with less than all engine cylinders activated during power take off.
